(19) United States
(12) Patent Application Publication
(10) Pub. No.: US 2004/0078787 A1
(43) Pub. Date: Apr. 22, 2004

(54) System and method for troubleshooting, maintaining and repairing network devices

(76) Inventors: Michael Borek, Lorton, VA (US); John Lusher II, College Station, TX (US); Paul Byrne, Dallas, TX (US); Mitch Lerman, Philadelphia, PA (US)

Correspondence Address: Michael J. Borek, 6905 Trestle CT, Lorton, VA, 22079, US

(21) Appl. No.: 10/620,349

(22) Filed: Jul. 17, 2003

Related U.S. Application Data
(60) Provisional application No. 60/397,344, filed on Jul. 19, 2002.

(51) Int. Cl. G06F 9/45

(52) U.S. Cl. 717/136; 717/174; 717/120

(57) ABSTRACT

Embodiments of the invention provide a network management tool for troubleshooting, maintaining, and repairing heterogeneous network devices. For example, in one embodiment, a user constructs a command for a selected network device using a graphical user interface. A device detection module then reads configuration information from the selected network device to create a device template. Next, a translation/parsing module translates the command into a format appropriate for the selected network device based on the device template, and sends the translated command to the selected network device. The translation/parsing module also translates data received from execution of the command on the selected network device, based on the device template.

### CROSS-REFERENCE TO RELATED APPLICATIONS

This application claims the benefit of and priority to provisional U.S. application No. 60/397,344, filed Jul. 18, 2002, the disclosure of which is hereby incorporated by reference in its entirety for all purposes.

### BACKGROUND OF THE INVENTION

The invention relates generally to the field of communications. More specifically, the invention relates to a system and method for troubleshooting, maintaining and/or repairing network devices.

With the increasing reliance of most every business on network interconnectivity, network operation is more critical than ever to the strategic objectives of the business. Even with advancements in available network management technologies, network downtime still persists as a major issue for network managers who are tasked with keeping the network highly available and optimally performing to support the needs of the business. The reason is that while existing network management technologies have provided necessary management and monitoring foundations for network managers, they have done little to impact the Mean Time to Repair (MTTR) network issues when they do arise. The reason is the underlying complexity and heterogeneity of most network environments that is created by: 1) each device manufacturer employing a different, proprietary device operating system that is particular to its own network hardware and sometimes is not fully compatible from version to version; 2) the lack of a communication standard capable of universally traversing the proprietary manufacturer device operating systems at a level of granularity beyond what is capable through Simple Network Management Protocol (SNMP) to be able to fully troubleshoot and diagnose network issues at their lowest level and across the various routing and transport protocols, such as Enhanced Interior Gateway Routing Protocol (EIGRP), Interior Gateway Routing Protocol (IGRP), Border Gateway Protocol (BGP), Asynchronous Transfer Mode (ATM), IS-IS, Open Shortest Path First (OSPF), Frame Relay and others, that are typically implemented on a device to allow it to interact with other devices on the network; 3) the required level of continuous interconnectivity that should be constantly maintained between network devices to form a seamless mesh of connectivity to allow applications and users to traverse the network; and 4) the constant amount of updating, tuning and adjustment typical on the part of devices on the network to be able to evolve with the constant dynamism of a properly operating network environment.

As a result of these limitations, troubleshooting/diagnosis, maintenance and repair of network failures remains a mostly manual process that requires specially trained and skilled network engineers to effectively diagnose network issues/failures that are detected and reported by the network management technologies typically employed in most network environments. Network engineers tasked with troubleshooting and diagnosing the network to isolate the true cause of a network failure: 1) traverse the network and interact with suspected devices using Telnet, 1970's shareware terminal emulation software that was originally designed for remote interfacing to mainframe computers, 2) execute specific, syntax sensitive troubleshooting/diagnosis commands particular to the specific manufacturer, operating system and type of the device suspected of causing a network failure, and 3) have the experience necessary to decipher the complex data that represents the operational aspects of the device to be able to identify and isolate a fault from typically a large volume of data and information controlling a specific device.

Additionally, because no effective management foundations exists to manage the manual processes of troubleshooting, diagnosing, maintaining and repairing network devices, network managers typically: 1) lack the ability to fully implement tiered security over these processes as engineers given full access to devices on the network to restore function to network failures, 2) have little to no ability to effectively capture, transfer and disseminate gained knowledge on how to troubleshoot, diagnose and repair specific network issues, and 3) have little ability to accommodate higher volumes of network issues and create economies of scale to increase the effectiveness and efficiency of their staff other than to hire additional engineers.

What is needed is a network engineering tool that: 1) eliminates the need for users to issue syntax-sensitive, textual commands to numerous proprietary manufacturer device operating systems; 2) eliminates the need for direct interface to Telnet; and/or 3) allows users to create multiple-step commands and other automated routines to automate specific troubleshooting, diagnosis, maintenance and repair processes.

### BRIEF SUMMARY OF THE INVENTION

Embodiments of the invention provide a network management tool for troubleshooting, maintaining, and repairing heterogeneous network devices. For example, in one embodiment, a user constructs a command for a selected network device using a graphical user interface. A device detection module then reads configuration information from the selected network device to create a device template. Next, a translation/parsing module translates the command into a format appropriate for the selected network device based on the device template, and sends the translated command to the selected network device. The translation/parsing module also translates data received from execution of the command on the selected network device, based on the device template.

### BRIEF DESCRIPTION OF THE DRAWINGS

Embodiments of the invention are described with reference to the following drawings, wherein:

FIG. 1 is a block diagram of a logical system architecture for use in creating a open connection to various network devices, according to one embodiment of the invention.

FIG. 2 is a process flow diagram for detecting a type of device, manufacturer and corresponding operating system being run by a device selected by a user, according to one embodiment of the invention.

FIG. 3 is a process flow diagram of a command translation/parsing method that is used to translate commands executed by the user in the graphical user interface into the appropriate command and necessary syntax to execute, according to the manufacturer, type and operating system of a particular device, according to one embodiment of the invention.

FIG. 4 is an illustration of a graphical user interface, according to one embodiment of the invention.

FIG. 5 is a process flow diagram of a Visual Command/Routine Development Method to create new customized commands and routines, according to one embodiment of the invention.

### DETAILED DESCRIPTION

Although SNMP is capable of universally communicating to network devices, and thereby navigating the variability of the different proprietary device-operating-systems employed by the various network device manufacturers, it is only capable of simply querying the device and gathering data about its performance and overall availability. SNMP is unable to query the protocols running on the device, the most delicate aspect of the dynamic interconnectivity that constitutes the network and the most frequent source of network issues and failures.

As a result of the complexity of today's dynamic, interconnected network environments and the limitations of SNMP, most exiting network management technologies are unable to provide an adequate level of visibility inside the devices on the network and the protocols running on the network, (beyond simple fault detection and surface level source analysis and prediction through fault correlation and other pattern recognition techniques that simply provide guesstimates as to where to begin troubleshooting network failures) to automatically determine and isolate the true cause of a network failure.

To illustrate consider the following categories of existing network management technologies.

Network Monitoring and Management technologies are primarily focused on monitoring the overall performance of the network and conducting very rudimentary, surface level, fault detection to identify the presence network failures in real-time. These technologies typically rely on the use of SNMP to interact with the numerous devices on the network and on proprietary software resident on each device to continually poll the availability of the device and to gather statistics and data to determine its performance in real-time. While the performance visibility and the instantaneous fault detection capabilities these technologies offer are useful for network managers to see network problems as they occur, in general these technologies are often unable to accurately isolate specific devices responsible for failures from those downstream from the failure that are simply being impacted as a result of the failure itself. Additionally, these technologies are typically unable to drill down into failures to determine their source within a specific device or grouping of devices because SNMP's query capability is limited and is unable to query the routing and transport protocols operating on a particular device across layers 2 and 3 of the Open Systems Interconnect (OSI) model, the originating source of a majority of network related device failures.

Configuration Management technologies are designed to manage the numerous configuration files that are used to configure and initiate a network device onto a particular network environment. Many vendors of these technologies have created graphical interfaces for the purposes of reducing the need for an engineer to have to understand the configuration specific commands according to the specific manufacturer, operating system and type of device necessary to configure a device to bring it into an operational state that is compatible with the design and running state of a particular network environment. While the elimination of many of the manual aspects of configuring a device to initialize it and make it operationally compatible with a network environment are helpful, their value in assisting the troubleshooting/diagnosis, maintenance and repair of network failures is limited as they, in general, are only able to analyze differences between a known-working good stored configuration and the current running configuration for a particular device. While this method can detect changes that may have occurred to the baseline configuration of an operational device, configuration-related changes represent only a small fraction of the possible universe of issues that can result in device failure. Additionally this approach often does not account for the fact that device configurations are often changed as part of the ongoing dynamism of most network environments. This results in updated configuration elements that are often not updated in stored configuration elements, which are used as the basis for making configuration comparisons. As a result of comparisons to diagnose network issues, new issues can be created unintentionally that can have more dire impact than the original issue trying to be detected.

Fault Management technologies attempt to extend beyond the basic network monitoring and fault detection capabilities resident in network management technologies. Fault management technologies leverage stored history about previously occurring network issues and apply advanced fuzzy logic, algorithms and other intelligence schemes in an attempt to better hone in on the source of a particular network issue. Through trend analysis, event correlation, and outage histories these technologies help narrow the starting point for network support engineers to begin manually diagnosing the network, isolating the true cause of the failure and ultimately repairing the issue and restoring service. Although these technologies are not capable of eliminating further diagnosis of the network issue, they benefit network managers by limiting the number of possible sources of the issue and thereby better guiding support resources to diagnose the issue and restore service.

In one respect, embodiments of the invention allow network engineers to work in a familiar but more intuitive, graphical, exponentially more efficient network diagnosis/troubleshooting, repair and maintenance environment that eliminates many manually intensive tactical tasks from their responsibility; all without limiting the power and flexibility of the underlying proprietary manufacturer's device operating systems.

In another respect, embodiments of the invention allow network managers to tighten security by 1) being able to assign individual rights and permissions to specific users or groups of users; 2) eliminating the users from need to have direct access to the sensitive device passwords that are currently required for users to access suspected devices as part of the troubleshooting, diagnosis, maintenance and repair process; 3) maintaining detailed logs and audit trails both by user and by device so that changes performed on a device or a group of devices can be easily undone if a change does not have the anticipated effect of repairing a network failure or if it was done without permission; and/or 4) storing device passwords and other sensitive access information in, for example, a secured 128 double encrypted database (or other secure database), while transparently supporting existing server- and device-based security specific authentication techniques.

In another respect, embodiments of the invention eliminate the need for network engineers to directly access Telnet, but still allows them 1) to tap the full power of Telnet, and the full commands and routines available in each of the proprietary device operating systems supported by each network hardware manufacturer; and 2) to work directly within a raw Telnet session that is optionally embedded in a more flexible software tool.

In another respect, embodiments of the invention automate many tactical, manually intensive front-line diagnosis/troubleshooting routines/processes and provides network engineers with a number of high-end specialized tools and utilities that make very complex, manual and difficult tasks like building summarization statements (that represent many networks being advertised to other network devices as a single statement instead of as many individual statements) as easy as a mouse click. Embodiments of the invention also simplify, and make more efficient, the building and testing of access-lists, comparisons of live device configuration files to stored back-up files and the mapping of IP address to Physical Port addresses automatically across a network.

In another respect, embodiments of the invention allow network engineers to build, test and deploy new commands and automated troubleshooting, diagnosis, maintenance and repair routines either by 1) using a macro-record like capability to save specifically executed commands in a graphical environment for future use; and 2) by using a visual development environment to construct new user-defined commands, multi-step commands and other automated routines by selecting and combining elements of issued device specific commands executed directly in a raw Telnet window.

In another respect, embodiments of the invention provide advanced knowledge-sharing capabilities that allow network managers and engineers to create templates for the specific purpose of capturing specific troubleshooting, diagnosis, maintenance and repair processes, commands, and interpretations to allow senior engineers to effectively capture and share their experience and expertise with lower level engineers.

In another respect, embodiments of the invention allow network engineers to automatically traverse the network by graphically selecting network devices they wish to troubleshoot, diagnose, maintain or repair.

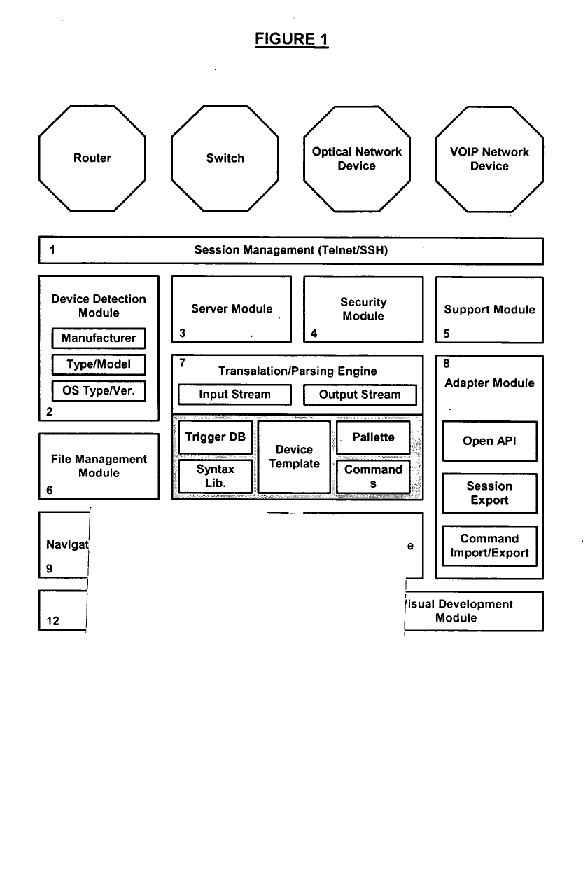

FIG. 1 is a block diagram of an architecture for a network interface tool (hereinafter “the tool”) for use by network engineers or other administrators, according to one embodiment of the invention. As shown therein, the tool may include the following components, numbered (1) through (13).

The Session Management Module (1) employs a Telnet, Secured Socket Handler (SSH), or other interface to open a connection to the selected device. The Session Management Module (1) also holds the connection open as long as needed to support the activity desired by the user and it interfaces directly with the Input and Output Stream Modules of the Translation/Parsing Engine (7).

The Device Detection Module (2) is responsible for detecting the manufacturer, type, operating system and other variables of a particular network device selected by the user for troubleshooting, diagnosis, maintenance and/or repair activity. This Module (2) is responsible for storing and maintaining template files for each type of device supported within the tool and sending the appropriate template file to the Translation/Parsing Engine (7) upon the user selecting a device in the User Interface Module (12) and the device being accessed as instructed by the Navigation Module (9). Each device Template file may contain a list of Parsing Triggers that instruct the Input Stream Module of Translation/Parsing Engine (7) how to interpret and parse the incoming data stream from a device so that the incoming data can be delineated, displayed and understood by the user; a Syntax Library that informs the Output Stream Module of Translation/Parsing Engine (7) of the appropriate syntax required to format any outbound commands executed by the user through the User Interface Module (12); a list of available system commands and commands, multi-stage commands and automated routines defined by users that are available to be executed on the device; and/or a list of Command Pallets that are used by network managers and network engineers to organize, group and logically display the command options available to the user.

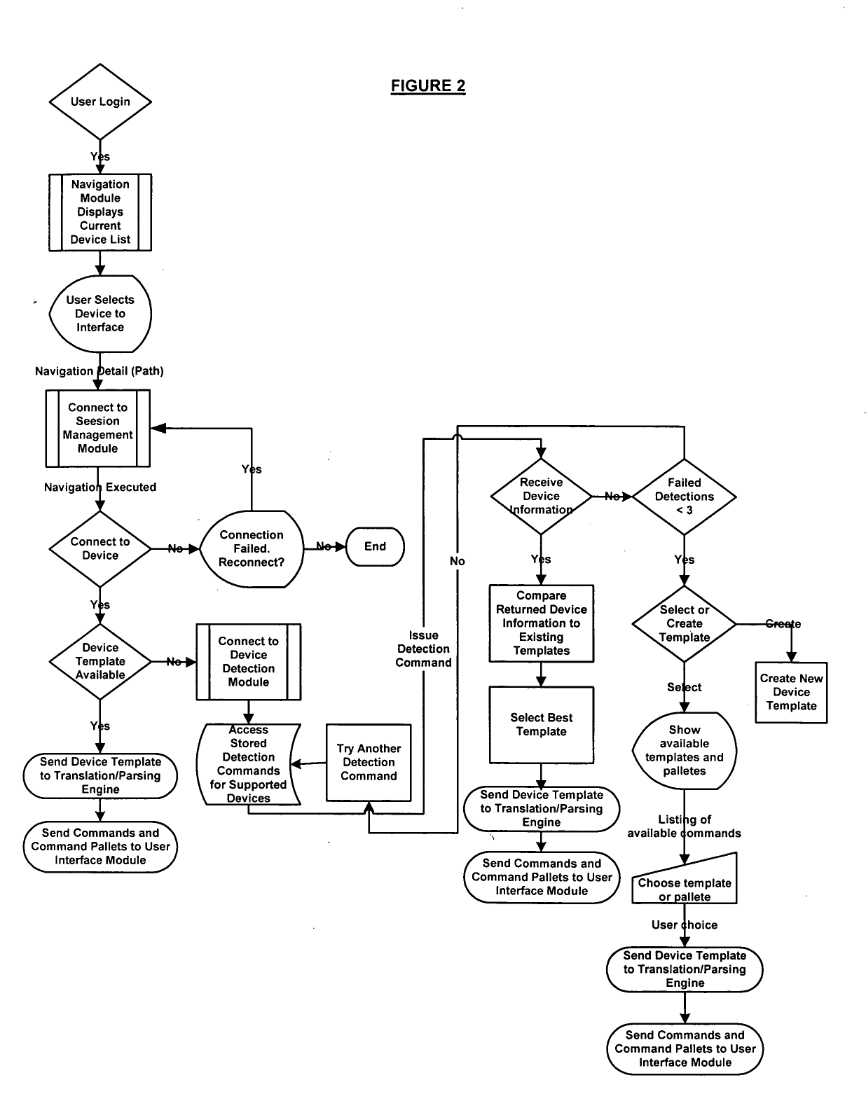

FIG. 2 is a process flow diagram for detecting a type of device, manufacturer and corresponding operating system being run by a device selected by a user, according to one embodiment of the invention. As shown in therein, after a user logs into the tool and selects a device to access from the list of available devices, as populated by the Navigation Module (9), the system opens a connecting to the Session Management Module (1) using the path to the device as maintained by the Navigation Module (9). Once a connection to the device is opened, the system then determines if an existing Device Template for the accessed device exists. The Device Template contains the list of available system commands, user defined commands and routines available for the device, the particulars of the device including the manufacturer, the type, version and operating system it runs; a list of parsing triggers that are used for delineating data returning from the device; and a syntax library for ensuring commands are properly formatted for sending and executing according to the specifics of the device's configuration.

If a Device Template for the Device already exists, the Device Template is sent directly to the Translation/Parsing Engine (7) for use in governing the system interaction with the device. If a Device Template is not available for the Device (usually if a device has not been previously accessed), then the Device Detection Module (2) is initiated. The Device Detection Module (2) accesses stored detection commands (a library of commands that are used on different device operating systems to identify the particulars of the device, including but not limited to device type, device manufacturer, device model, operating system, operating system version, and others) and issues detection commands sequentially to the device until it can detect the particulars of the device and identify the correct Device Template to use for interacting with the device.

If the device is still unknown after a number of attempts by the system to detect it, the user is then prompted to select which Device Template to use for interacting with the device. Whether the device is detected by the system or a Device Template is identified by the user, the Navigation Module (9) is updated with an association to the selected Device Template so that the next time the device is accessed the Device Detection process can be bypassed and the system can automatically identify the correct corresponding Device Template and send it to the Translation/Parsing Engine (7) for processing the device interaction. The result of this process is that the best Device Template for managing the interaction to the selected device is sent to the Translation/Parsing Engine (7) for processing the interaction with the selected device.

Returning to FIG. 1, the Server Module (3) is a system module that manages the concurrent use of the tool environment by multiple users. This Module (3) is responsible for maintaining active user connections with users, controlling the operational variables of the tool environment, such as the number of concurrent users supported by the license agreement, and provisioning and marshalling system resources to the various activities ongoing in the tool environment at any given time. tool provides each user with a unique workspace that they are able to manage and customize to their personal preferences. The Server Module (5) is responsible for storing each user account and serving that account to the appropriate user when requested by the User Interface Module (12). The Server Module (3) also ensures that the tool is capable of running on any underlying server operating system including, but not limited, to Windows, Windows NT, Windows XP, Window 2000 Advanced Server, Windows 2003, Windows 2003 Server, Linux, Unix, and other commonly used server operating systems. The Server Module interfaces with the File Management Module (6) and the User Interface Module (12).

The Security Module (4) is responsible for storing all security files pertaining to users, devices, areas of the network, commands, and other elements secured by the tool. The Security Module (4) is also capable of interfacing with other 3^{rd}-party security systems, such as TAC-ACS and other security technologies that are used by network managers to secure their network environment. The Security Module (4) is interfaced whenever a user authenticates to the tool, whenever a user performs a command through the tool environment on a registered device, whenever a device is accessed, whether that is the destination device or an intermediary device that is accessed to traverse the network, and whenever am element of the tool is modified, be it a template, a command or any other modifiable element. The Security Module (4) is responsible for monitoring and recording all activity occurring in the tool to populate system logs, audit trails, and other files. The Security Module (4) interfaces with the Navigation Module (9), the User Interface Module (12) the Reporting Module (11), the Adapter Module (8), the File Management Module (6), the Support Module (5), the Template Module (10), the Server Module (3) and the Translation/Parsing Engine (7).

The Support Module (5) allows for the remote support and administration of the tool environment. Specifically this Module (5) allows an administrator to report defects, bugs, incorrect command translation/parsing events, and to allow outside product support to update system files, to adjust the tool licensing components and to perform system diagnostic activity.

The File Management Module (6) is responsible for maintaining all data files associated with the tool environment; including log files of commands executed, audit trails that are organized by device and by user, commands, templates, command pallets, reports, system audits, and other data stored by the tool. All data managed by this Module (6) are encrypted. All Modules of the tool interface with this module.

The Translation/Parsing Engine (7) is a run-time environment comprising an input stream manager that is used to capture, read and translate the incoming data stream from a network device and an output stream manager that is responsible for sending appropriately formatted commands to selected devices according to the details contained in its template. Each device, device type and/or grouping of devices maintained as part of the Navigation Module (9) of the tool has a corresponding Template file. The Device Detection Module (2) is responsible for determining the appropriate template file to send to the Translation/Parsing Engine (7) based upon the manufacturer, type and version of operation system running on the selected device. Each device Template file contains: a list of Parsing Triggers that instruct the Input Stream Module of Translation/Parsing Engine (7) how to interpret and parse the incoming data stream from a device so that the incoming data can be delineated, displayed and understood by the user; a Syntax Library that informs the Output Stream Module of Translation/Parsing Engine (7) of the appropriate syntax required to format any outbound commands executed by the user through the User Interface Module (12); a list of available system commands and commands, multi-stage commands and automated routines defined by users that are available to be executed on the device; and a list of Command Pallets that are used by network managers and network engineers to organize, group and logically display the command options available to the user. In the process of executing commands to selected devices the Translation/Parsing Engine established an active Telnet, SSH, or other session with the Session Management Module (1) in order to allow the Input and Output Stream Modules to interact directly with the selected date.

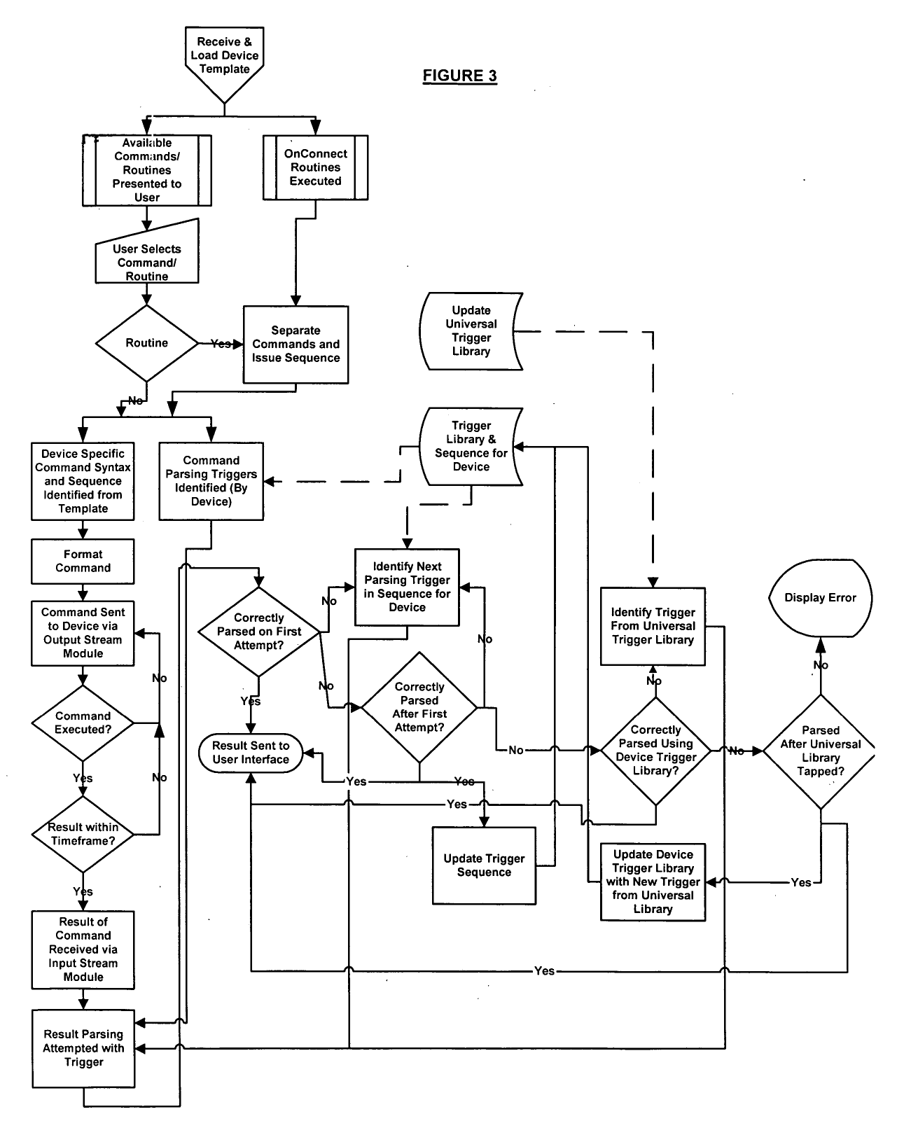

FIG. 3 is a process flow diagram of a command translation/parsing method that is used to translate commands executed by the user in the graphical user interface into the appropriate command and necessary syntax to execute, according to the manufacturer, type and operating system of a particular device, according to one embodiment of the invention. As shown therein, when the user selects a device to troubleshoot, diagnose, maintain or repair from the list of available devices maintained by the Navigation Module (9), the system either directly sends the associated Device Template of the selected device, or initiates the Device Detection Module (2) to determine the best Device Template to send to the Translation/Parsing Engine (7). As the Translation/Parsing Engine (7) receives the Device Template, the system sends the list of available commands organized by any saved command pallets (Pallets are created by users to organize and group like commands for specific devices) to the User Interface Module (12) to display to the user. In the User Interface Module (12) the user selects the command/routine that they wish to execute. The system sends this request back to the Translation/Parsing Engine (7) which then determines if the request is a command or a multi-step command or routine. If the request is a routine or multi-step command, the Translation/Parsing Engine (7) separates the individual commands and manages the issue of the commands according to the sequence identified in the routine.

The Translation/Parsing Engine (7) then identifies the specific command syntax and sequence identified by the Device Template for the command being executed. The command is then formatted according to the Syntax library and is then sent to the Output Stream Module to be sent to the Session Management Module (1), which passes the command to the device for processing. The command is executed on the device and the result of the command is received by the Session Management Modúle (1), which then passes the result to the Input Stream Module, which uses the parsing triggers associated with the device as provided by the Device Template to parse and delineate the incoming data stream for the device to properly display the resulting data properly in the display element associated with the command.

If the parsing is correctly performed the display elements are populated and the completed result is sent to the User Interface Module (12) for display to the user. If the parsing trigger used to parse the incoming result set generates an error, or is incapable of correctly delineating the resulting data into the display element, the Translation/Parsing Engine (7) accesses the device's Parsing Trigger Library and selects the next listed parsing trigger associated with the device. Parsing Triggers are stored according to device instead of by command because the underlying device operating systems for which the parsing triggers are developed for are used fairly consistent across all support commands. Alternatively, the system is capable of searching the records of each of the saved triggers in the Device Trigger Library to see if there is an association to the command that is currently being processed, and if so, it is capable of calling that particular trigger for first use, regardless of where it lies in the sequence in the Trigger Library itself.

If the Translation/Parsing Engine (7) locates a parsing trigger that successfully parses and processes the resulting data from the device, the system then updates the parsing trigger sequence in the device template to elevate the parsing trigger higher in the sequential listing of triggers stored in the Trigger Library in the Device Template and also to notate the trigger record with a reference to the command that was executed. This notation is done to provide the system with an alternative method for searching for the best parsing trigger to use in processing of a particular command.

The Translation/Parsing Engine (7) repeats trial and error process of calling additional parsing triggers from the Trigger Library for the Device Template until either 1) a parsing trigger from the Trigger Library contained in the Device Template is found to properly process the resulting data from the device, or 2) until all parsing triggers associated with the devices have been used to properly parsing and process the resulting data from the device.

If all parsing triggers in the Trigger Library of the Device Template are used and the resulting data has still yet to be successfully processed, the system then accesses the Universal Trigger Library that contains every parsing trigger used by the system since implementation. The system uses this broader library of parsing triggers to find a match either by 1) searching the records of each of the saved triggers to see if there is an association to the command that is currently being processed, or by 2) trying each remaining trigger in the Universal Library that has not already been executed as part of the process using the Device Trigger Library. If a trigger pulled from the Universal Trigger Library is used to successfully parse and process the command, the system then updates the trigger in the Device Trigger Library and notates the record of the Trigger in both the Universal and Device Trigger Libraries, indicating that the trigger has successful parsed and processed the command selected by the user. If after all of this the resulting data from the device still remains unparsed and unprocessed, the Translation/Parsing Engine (7) sends an error to the User Interface Module (12) to display to the user. Upon receipt of this error, the system simultaneously asks the user if they would like to record the error and send it to product support. If user selects this option the error report (including the error description) the displayed command, the device operating system formatted command and all of the triggers used to process the result are sent to the Support Module (5) to be sent to the appropriate internal or external organization to further investigate the error.

The Adapter Module (8) that includes adapters, or interfaces, to environments and systems external to the tool. This module contains, but is not limited to, three adapters: a Command Import/Export Adapter that is used to import and export user defined and developed troubleshooting, diagnosis, maintenance and repair commands created by the user in the Visual Development Module (13) for the purpose of either adding new features created by users to export existing or new features to other the tool implementations; a Session Export Adapter that is used to capture troubleshooting, diagnosis, maintenance and repair sessions conducted in the tool to build a repository of executed commands particular to specific types of network failures to further automate similarly occurring problems in the future; and a Open API adapter that can be used establish automated connections to various other network management and other technology systems for the purpose of coordinating data and information between these systems and the tool.

The Navigation Module (9) which stores an active listing of all devices on the network along with pertinent information for each device listed including, but not limited to: the device type, the physical path of the device on the network, the version of operating system running on the device and logical names used to represent the device. The Navigation Module (9) interfaces with the User Interface (12), the Device Detection (2), the Translation/Parsing Engine (7) and the Security Module (4) and as part of its operation updates data it stores on devices listed in its repository, while adding any new devices that are either directly accessed by the user or indirectly accessed by the system to traverse the network to make connections with selected devices.

The Template Module (10) allows users to create, store and transfer customized templates they create to modify and personalize their individual user accounts in the tool environment. A user has several options to customize their individual tool environment. A user can use the Macro Record capability to record sequences of existing commands for specific devices to create rudimentary routines for automating specific functions. A user can also create more sophisticated templates that allow the user to define thresholds and rules behind visual indicators, to create custom command pallets that contain for example the most widely used commands, tools and routines used for working with a specific device or grouping of devices, along with other embeddable elements to help either new or existing experience in performing troubleshooting, diagnosis, maintenance and repair processes on the underlying network environment. The Template Module (10) is separate from the Visual Development Module (13), which relates to the creation of new commands and routines that can then be organized, modified and combined with other existing commands as part of the Template Module. The Template Module (10) interfaces with the User Interface Module (12), the Navigation Module (9), and the Translation/Parsing Engine Module (7).

The Reporting Module (11) allows the user to develop customized reports to detail user activity, command, and device activity and other reports. The Reporting Module (11) allows the user to choose from available data constructs captured by the tool and to compile them into a useable format.

The User Interface Module (12) is the graphical intuitive environment that users use to navigate to devices they wish to conduct troubleshooting, diagnosis, maintenance and repair processes on. This Module (12) coordinates with the Navigation Module (9) to display available devices on which the user can work. This Module (12) also interfaces with the Security Module (4) to authenticate the user upon login to the tool environment, and it also interfaces with the Template (10), Reporting (11), Visual Development (13), and the Adapter Module (8).

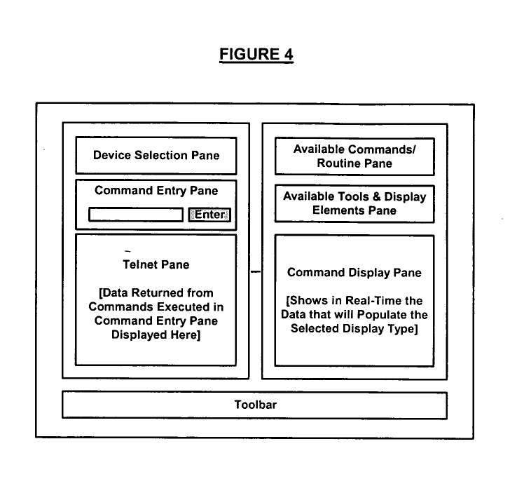

The Visual Development Module (13) is used by users to construct new commands, multi-step commands and automation routines that can be imported into the tool to extend and customize the available features and functions available for particular devices, groups of devices and the network as a whole. This Module (13) works, for example, as shown in FIG. 4 by providing the user with a dual pane workspace that allows the user to execute native operating-system commands to a selected device. This interface combines: 1) a Device Selection Pane (41) that allows the user to select an existing device they would like to create new commands/routines for or to add a new device to access; 2) a Command Entry Pane (42) that allows the user to type in a textual, native operating system command to execute on the selected device; 3) a Telnet Pane (43) that shows the result of executed commands; 4) an Available Commands/Routines Pane (44) that shows all existing system commands, user defined commands and routines that have been created and saved for the selected device; 5) an Available Tools & Display Elements Pane (45) that contains modifiable display elements for displaying the results of the command in the tool environment; 6) a Command Display Pane (46) that is used to show the user the constructed command and how it will be populated with data from executed commands; and 7) a Toolbar (47) that allows the user to perform actions on created commands.

Each of the foregoing panes described with reference to FIG. 4 are enabled by executable code in, or associated with, the tool. Thus, while an individual pane is configured to receive a selection or other user input, this input feature of the Visual Development Module (13) is associated with code to read the user input. Likewise, a pane in the Visual Development Module (13) that is configured to display data to a user is associated with code for outputting the displayed data to a monitor or other graphical output device.

In alternative embodiments, all panes described above with reference to FIG. 4 may not be included in the Visual Development Module (13). Moreover, in other embodiments, an interface pane other than the Telnet pane may be used in the alternative, or in combination with, the Telnet pane.

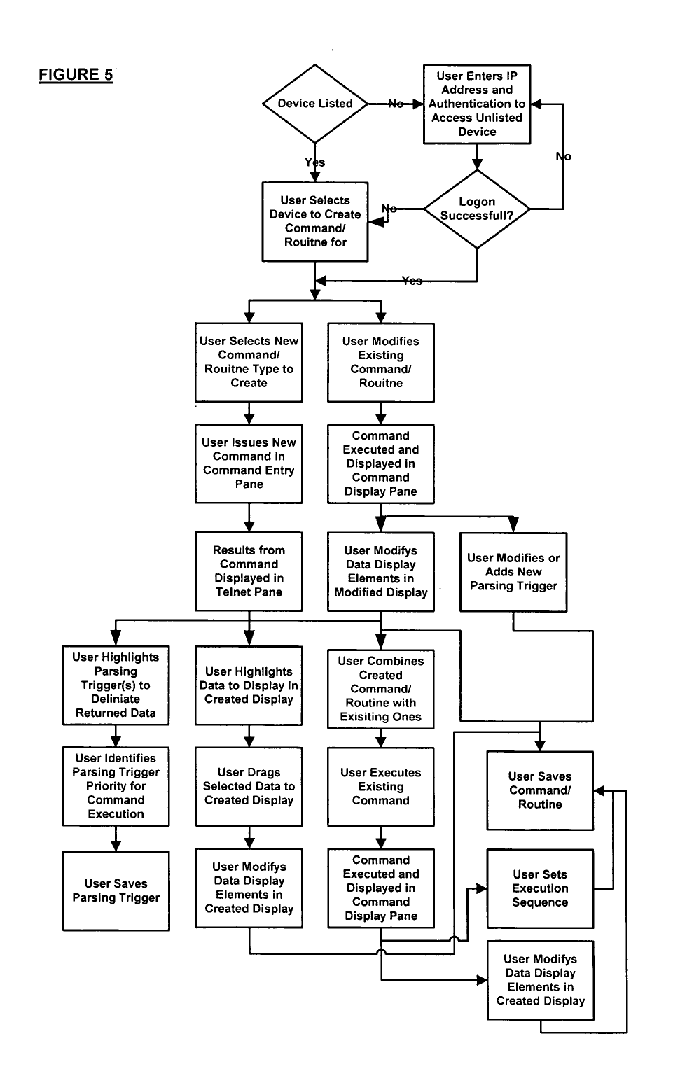

FIG. 5 is a process flow diagram of a Visual Command/Routine Development Method to create new customized commands and routines, according to one embodiment of the invention. As shown therein, the user starts by selecting the device they wish to create new commands/routines for by selecting the device from the Device Selection Pane which graphically lists all devices stored in the Navigation Module (9), or if the device is not present in this listing by providing the Internet Protocol (IP) address of the desired device and the authentication required to access it and establish a session with it. Once the device is selected or the information for accessing a non-listed device is received, the Session Management Module (1) is initialized to establish a connection with the device. Once connected, the user can either choose to create a new command/routine or to modify/delete an existing command/routine. If the user selects to create a new command/routine, the user selects the type of command to create from a listing of available types for the device. Once a type has been selected, the user then issues commands in the Command Entry Pane. In this Pane, the user constructs textual, native commands of the particular operating system of the device connected. The command entered is then sent directly to the Session Management Module (1) for immediate delivery to the device and execution (versus being sent to the Translation/Parsing Engine (7) for format delivery). The command is executed and the result is then received and displayed for the user in the Telnet Pane. Once the result is listed in the Telnet Pane, the Telnet Pane becomes the active Pane and the user is capable of highlighting any of the resulting text to 1) identify and save parsing triggers (characters returned by a device that are used to delineate the data of the result set) that will be stored for the command in the Device Template for using in parsing the command during execution by the Translation/Parsing Engine (7), and 2) to highlight actual returned data to populated created command displays. Highlighted data elements can then be dragged from the Telnet Pane to the Command Display Pane and placed in any of the appropriate display elements (tables, charts, etc) created by the user in this Pane. It is in this Command Display Pane that the user can construct commands/routines, by incorporating display elements to the command/routine being developed or modified. Once the selected data has been dragged to the Command Display Pane, the user can then modify the data, can manipulate its display in selected display elements and can combine different commands, data elements and display elements to create customized routines that follow the defined processing sequence defined by the user. Once new commands and routines are developed by the user, the user saves the command/routine to a local drive or network location and then uses the Import/Export Adapter of the Adapter Module (8) to incorporate them into the tool environment.

Although FIG. 5 is described with reference to a Telnet pane, panes having another interface type could also be used.

The architecture in FIG. 1 may be implemented in hardware, software, or a combination thereof, and may be configured to perform any one or all of the processes depicted in FIGS. 2, 3 and 5 and described above. Any one or all of the processes depicted in FIGS. 2, 3 and 5 and described above may be implemented in hardware, software, or a combination thereof. Software embodiments of the architecture in FIG. 1, the processes of FIGS. 2, 3 and 5 and/or the graphical user interface of FIG. 4 may be stored as code on a computer-readable medium such as a hard drive, Compact Disc Read Only Memory (CDROM), Random Access Memory (RAM) or other storage device.

While this invention has been described in various explanatory embodiments, other embodiments and variations can be effected by a person of ordinary skill in the art without departing from the scope of the invention.

What is claimed is:

1. A network maintenance tool, comprising:
an interface associated with at least one network device;
a device detection module coupled to the interface, the device detection module configured to receive at least one device parameter from the at least one network device and to generate a device template based on the at least one device parameter; and
a translation engine coupled to the device detection module, the translation engine configured to store the device template.

2. The tool of claim 1, wherein the translation engine is further configured to translate a command received from a user based on the device template, the translation engine is further configured to send the translated command to the at least one network device.

3. The tool of claim 1, wherein the translation engine is further configured to parse a command received from a user into a plurality of parsed commands, translate each of the plurality of parsed commands based on the device template, and send the translated plurality of parsed commands to the at least one network device.

4. The tool of claim 1, wherein the translation engine is further configured to read and translate incoming data from the at least one network device based on the device template.

5. The tool of claim 1, further comprising a visual development module configured to allow a user to construct device-specific commands.

6. Code associated with a graphical user interface for use with a network maintenance tool, the graphical user interface allowing a user to construct device-specific commands, comprising:
a device selection pane code configured to receive a user selection associated with a device;
a command entry pane code configured to receive a user-selected indication of a command associated with the device, the command being based on a native operating system; and
a interface pane code configured to send data based on execution of the constructed command.

7. The graphical user interface of claim 6, further comprising:
an available commands pane code configured to output all previously defined commands for the selected device; and
an available display element pane code configured to output modifiable display elements for displaying the data based on execution of the constructed command.

8. A method for managing a network device, comprising:
constructing a command for a selected network device;
reading configuration information from the selected network device;
creating a device template based on the configuration information;
translating the constructed command into a format appropriate for the selected network device, the translating based on the device template; and
transmitting the translated command to the selected network device.

9. The method of claim 9, wherein constructing the command is enabled by a graphical user interface.

10. The method of claim 9, wherein translating the constructed command includes parsing the constructed command into a plurality of parsed commands, each of the parsed commands formatted appropriately for the selected network device.

11. The method of claim 9, further comprising translating data received from the selected network device, the data resulting from execution of the translated command, the translating received data based on the device template.

12. A system for managing a communications network, comprising:
a graphical user interface configured to enter and issue a router command;
a translator coupled to the graphical user interface, the translator configured to translate the router command into a format appropriate for a router; and
a link to the router, the link coupled to the translator and configured as an Input/Output Supervisor having a Command Line Interface.

13. The system of claim 12, wherein the graphical user interface is further configured to issue the router command based on customized command Macros.

14. The system of claim 12, wherein the graphical user interface is further configured to receive and display data from the router.

15. The system of claim 12, wherein the link includes a Telnet emulator.
